(19) United States
(12) Patent Application Publication
(10) Pub. No.: US 2020/0106732 A1
(43) Pub. Date: Apr. 2, 2020

(54) Method and System for Managing Electronic Mail

(71) Applicant: Michael Keenan, II, Binghamton, NY (US)

(72) Inventor: Michael Keenan, II, Binghamton, NY (US)

(21) Appl. No.: 16/524,102

(22) Filed: Jul. 28, 2019

Related U.S. Application Data
(60) Provisional application No. 62/739,191, filed on Sep. 29, 2018.

(51) Int. Cl. H04L 12/58; G06Q 10/10

(52) U.S. Cl. CPC H04L 51/18; G06Q 10/107; G06Q 10/1095; H04L 51/22

(57) ABSTRACT

Method and system for more effectively managing email correspondence are provided. An email recipient's email account, in response to receiving an email from an email sender, automatically sends to the email account of the email recipient and/or to the email account of the email sender a calendar invitation scheduling follow up between the email sender and the email recipient. The method and system provided may be configured such that calendar invitations are automatically sent only when an email is received from certain persons, at a certain time, or from certain persons during certain times. The method and system may also be configured so that calendar invitations automatically sent to email senders vary from the calendar invitation automatically sent to the email recipient's email account.

### PRIORITY CLAIM

This application claims the benefit of U.S. Provisional Application No. 62/739,191, filed Sep. 29, 2018.

### FIELD OF THE INVENTION

The field of the present invention is methods and systems for managing incoming electronic mail and specifically relates to a method and system for managing incoming electronic mail when the intended recipient is out of the office for a period of time.

### BACKGROUND OF THE INVENTION

Electronic mail (“email”) has become ubiquitous in the business world, both in the United States and abroad. For many professionals, email is primary method by which they communicate with colleagues and customers. It is not unusual for professionals to receive anywhere from twenty (20) to well over one hundred (100) emails per day.

Communication by email has become ubiquitous for several reasons. One of the most significant reasons that email has become so popular among professionals is that written emails, like letters, create a verifiable written record of communication (with email delivery being near instantaneous, as opposed to the relatively slow pace of letters). For many professionals, including lawyers and business professionals, having a written record of communication is immensely valuable. For example, in many (if not all) United States jurisdictions, an exchange of emails by which one professional agrees to provide goods or services for a specific price constitutes an enforceable contract. While reliance on an email exchange is in most cases not the ideal means of enforcing an agreement, having a written record evidencing the agreement is nevertheless extremely valuable and can serve as a “fail safe” in the absence of a more formal contract.

Even where a record of email correspondence is not necessary to serve as evidence, having a written record of communication provides numerous other benefits. For one, the written record of communication can serve as a reminder to either a sender or recipient of an email. Because most email systems (such as Microsoft Outlook, Google's G-Mail, Yahoo! Mail, etc) are searchable and store old emails for long periods of time (and in some cases in perpetuity), either a sender or recipient of an email can go to their outbox or inbox, respectively, to search for a previously sent or received email in order to review the information contained in the email.

Email also is often more convenient than other forms of communication. For example, many professionals work in the office during normal business hours (9:00 AM to 5:00 PM) or hours that are reasonably similar to normal business hours (for example, 8:30 AM to 6:00 PM). But it is not unusual for people to perform additional work from home (or another remote location) during the evening (or late night/early morning). During these “non-normal business hours,” professionals generally cannot be reached on their office telephone because they are not physically in their office. And in the absence of a truly urgent need, calling someone who is not a close friend on their cell phone late at night or early in the morning is generally considered a breach of business etiquette. But because many professionals receive email on their smart phone, which they have with them during non-normal business hours, sending an email is an effective way to contact a professional outside of normal business hours (many professionals also have their laptops, tablets, or other portable devices with them when they leave the office and these devices also offer on-the-go email access).

In addition, the modern workforce is increasingly comprised of millennials and other young professionals who grew up with text messaging (“texting”) and other forms of instant messaging as a major form of communication. Social media platforms, such as Facebook and Instagram, also include instant messaging features that often have been widely utilized by young professionals during the time they grew up (and often continue to be utilized by professionals of all ages). This regular use of texting and similar means of instant message communication has resulted in many young professionals having, as compared to older professionals, an increased level of familiarity and fondness with email. Because most people respond to emails they receive, an increased use of emails by one segment of the population prompts the rest of the population to also send emails in response.

Finally, the impersonal nature of email appeals to many people. When you meet with someone in person or call them on the telephone, you are forced to interactively engage with a person. With email, however, there is no personal interaction. An email allows a sender to state all of their thoughts, uninterrupted, and without any real-time rebuttal or engagement from the email recipient. For many, this type of impersonal communication is preferable.

The multiple reasons noted above regarding why email is so widely utilized among professionals, as well as other reasons not discussed herein, have created the situation described above whereby professionals receive huge amounts of emails each and every day.

### Additional Benefits of Email Platforms

Modern email platforms (such as Microsoft Outlook, Gmail, etc) also provide or are linked with other technological tools that provide additional benefits to professionals. Most relevant to the present invention, many modern email platforms include or are linked to an electronic calendar. Electronic calendars are immensely valuable to modern day professionals. One reason they are so valuable is that electronic calendars are now present on smart phones that professionals typically carry with them at all times. This means that professionals have access at all times to their entire calendar of appointments merely by looking at their phone.

Two additional benefits of modern electronic calendars are the calendar invitations and reminder functions. For calendar invitations, when professionals wish to schedule a meeting with someone else, a professional can send what is commonly referred to as a “calendar invite.” A calendar invite arrives just like an email and when it arrives it describes the proposed meeting in whatever terms the sender has chosen, shows the time of the meeting, and states the place (if the sender has specified a location). If the proposed meeting is a conference call or video call, the calendar invite will include the information necessary to enable the receiver to join the call.

A significant benefit of calendar invites is that sending the calendar invite automatically puts the proposed meeting on the recipient's electronic calendar that is linked to the recipient's email account. When the calendar invite puts the proposed meeting on the recipient's calendar, the proposed meeting is often marked in some fashion as being “proposed.” For example, appointments on the recipient's calendar are often shown as time that is “blocked off” on the recipient's calendar. The “blocking off” is often in a specific color (say, for example, royal blue). When a calendar invite arrives, many email and electronic calendar platforms will put the proposed meeting on the recipient's calendar in a different color (say a lighter shade of blue) to indicate that the meeting is, at that time, merely proposed.

The calendar invite also arrives with “buttons.” The buttons included on a calendar invite typically include some variation of Accept, Reject, or Propose a Change. If the recipient accepts the meeting as proposed by clicking the Accept button, the meeting that was recorded on the recipient's calendar in light blue to denote that the meeting was merely proposed (continuing the color example above), will now change to royal blue like every other meeting on the recipient's calendar to denote that the meeting is no longer merely proposed. If the recipient rejects the proposed meeting by clicking the Reject button, the proposed meeting will disappear from the recipient's electronic calendar. Finally, if the recipient clicks the Propose a Change button, the recipient can alter the terms of the proposed meeting (such as by proposing a different time) and the recipient will then send back to the original sender a new calendar invite with the new calendar invite specifying the altered meeting terms. The original sender can then accept, reject, or propose a further change to the altered meeting terms according to the same procedure described above.

The reminder feature is also helpful. When a professional puts an appointment on their electronic calendar, the professional can set a reminder to ensure that the professional does not forget about the appointment. For example, the professional can schedule a reminder whereby twenty-four hours before a scheduled meeting, a notification will automatically “pop up” either within their email platform or on their smart phone (or both) that reminds the professional that the appointment is scheduled to take place in twenty-four hours. In many cases, reminders are automatically set up within the electronic calendar system so that a person receives a reminder for every appointment before it occurs without ever having to take any action to cause the reminder to pop up. A typical automatic reminder may pop up 15 minutes before a meeting is scheduled to occur.

### The Problem of Mass Emails when Recipients are Away

The huge number of emails that professionals receive each day create a problem when professionals are out of the office. For example, say a lawyer receives 50 emails a day (which in some cases may be a conservative estimate). If that lawyer is on vacation for a week and cannot (or would prefer not to) regularly check their email, a five-day business week of unchecked emails would mean that the lawyer will return from vacation to 250 unchecked emails. Sorting through 250 unchecked emails upon the lawyer's return to the office will be a very time consuming task, especially because while the lawyer is attempting to sort through the 250 emails that arrived while the lawyer was on vacation, another 50 emails are arriving every day. Further, upon return to the office, the lawyer likely needs to perform work other than just checking emails, which means the lawyer cannot simply sit for hours sorting through a deluge of emails. As a result, many professionals that come back to this sort of deluge of emails find it very difficult to check the mass of emails with the level attention needed to ensure that nothing important is missed. In some cases, professionals may simply skim through their inbox to look for emails from important people and give far less attention to emails from any other senders even though some of those emails may be of significant importance. For example, an employee who works for a large client but with whom a lawyer is unfamiliar may have emailed the lawyer while the lawyer was on vacation. Because the lawyer does not recognize the employee's email, the lawyer may skim past the email without giving it due attention, even though the employee may have been emailing about a very important issue.

Although a lawyer has been used in the above example, the problem of returning from vacation (or otherwise being out of the office) to an unmanageable amount of emails is a problem that affects all professions. For example, a marketing professional may return to a deluge of emails and overlook an email, but that email could, for example, claim that the marketing company is infringing the sender's trademark in a marketing campaign the professional is conducting for a client. Or in the medical field, a physician may come back to a deluge of emails and overlook an important email regarding a patient matter. Or a CEO could overlook an email from a valued contact and, by inadvertently ignoring the email, damage the relationship with the contact. All of these are merely examples. In every profession, coming back from time out of the office to an unmanageable amount of emails creates a risk that something important will be overlooked.

Current email systems do not offer any sufficient technological solution to enable professionals to adequately manage the deluge of emails that they receive while out of the office. For example, the most common technological solution current email systems offer to help manage the receipt of emails when a professional is out of the office is an “automatic out of office response” (hereafter referred to as “Out of Office Response”). An Out of Office Response, however, offers nothing in the way of a technological solution to help manage the volume of emails that a professional receives while out of the office. Rather, an Out of Office Response merely sends an automatic reply email to the first email that a particular person sends to the professional once the professional has activated the Out of Office Response. A typical Out of Office Response informs a person sending an email to a professional who is away that the professional is out of the office, when the professional will return, and provides a person to whom the sender can reach out if they are experiencing an urgent issue. While an Out of Office Response is preferable to having no method of acknowledging that the professional is away, and may dissuade people from sending multiple emails while the professional is out of the office (after receiving the first Out of Office Response indicating that the professional is away), the Out of Office Response offers no benefit at all toward managing the deluge of emails that arrive while the professional is out of the office.

It should be noted that those of skill in the art will understand that many email platforms such as Microsoft Outlook enable users to send different Out of Office Responses to different groups of people. For example, a professional may set up their Out of Office Response so that a different Out of Office Response is sent to the professional's intra-company colleagues than the Out of Office Response that is sent to any person who does not work at the same company as the professional. Enabling an email platform to allow an email user to automatically send different Out of Office Responses to different groups of people is within the common knowledge of those with ordinary skill in the art.

Non-technological solutions also offer no sufficient method of enabling professionals to manage the deluge of emails they receive while out of the office. For example, although support staff may take phone messages and draft reminder notes for a professional to review when the professional returns, support staff are not always (and in many cases are not often) carbon copied (hereafter “copied”) on a particular email. In the case where a professional's support staff are not copied on an email that a person sends to the professional when the professional is away, there is no way for the support staff to review the email as it arrives and prepare a note regarding the email's contents for the professional to review upon returning to the office.

Furthermore, asking support staff to monitor all the emails that a professional receives while out of the office is not feasible. In many cases, support staff do not have unfettered access to the email accounts of the professionals that they assist. In fact, cyber security best practices counsel against allowing employees to access the email accounts of other employees. Thus, in many instances, there are technological and administrative hurdles that prevent support staff from monitoring a professional's email while the professional is away. Furthermore, support staff have many tasks to perform. Support staff cannot spend all of their time monitoring a professional's email account. And even if support staff tried, they are people—inevitably, a phone will ring and while the support staff is answering the call (or dealing with a client who has come into the office, or otherwise tending to an urgent need) an important email (or several emails) may arrive and the support staff who was distracted when the email arrived will fail to note that the important email has arrived and so will fail to remind the professional to respond to it when the professional returns to the office. Support staff also have work of their own to perform; they simply cannot spend all day monitoring a professional's email inbox. Thus, there is no non-technical solution that can reliably assist professionals with managing the massive amount of emails they receive while out of the office and ensuring that important emails received while the professional was out of the office are not overlooked.

Human nature also plays a part in the difficulty of managing the receipt of so many emails while a professional is away. From the perspective of the professional who was away (and as noted above), reviewing the huge volume of emails that arrive while the professional is out of the office may seem like a daunting task that the professional simply gives up on completing. Some professionals may figure that if an issue contained in an email sent while the professional was away was sufficiently important, the sender will send a second email once the professional has returned to the office. This assumption, however, may result in a professional losing business because the sender, having never received a response from the professional after the professional returns to the office, seeks out a competitor of the professional to address the issue that was raised in the email sent while the professional was out of the office. This assumption may also result in bigger trouble: if the sender asked for a response and the professional neglects to respond, the failure to respond in certain circumstances could constitute professional negligence. Similarly, an email sender who receives an Out of Office Response may put off the issue that was raised in the sent email, intending to again address the email when the professional returns. But if that sender gets busy around the same time that the professional returns to the office, the sender may forget to follow up with the professional regarding the issue. This failure to address the issue could result in damaging consequences for the sender, which in turn may damage the sender's relationship with the professional.

Numerous publications have noted the issue of professionals returning to an unmanageable volume of email messages after having been out of the office for a period of time. Bourree Lam, What Are Employers Doing to Reduce the Onslaught of Work Emails, The Atlantic (Mar. 2, 2016), https://www.theatlantic.com/business/archive/2016/03/too-many-emails/471918/; Dan Zak, Caitlin Gibson, Ben Terris, I Came Back to 4,459 Emails: Washington is Back to Work, and In a Tizzy, The Washington Post (Jan. 28, 2019), https://www.washingtonpost.com/lifestyle/style/i-came-back-to-4459-emails-washington-is-back-to-work-and-in-a-tizzy/2019/01/28/c3246260-2315-11e9-ad53-824486280311_story.html?utm_term=.bd58e830c6ed; Thomas Tamblyn, We Are Beginning to Feel Crushed by the Number of Work Emails We Get, The Huffington Post (Mar. 23, 2016), https://www.huffingtonpost.co.uk/entry/we-are-beginning-to-feel-crushed-by-the-number-of-work-emails-we-get_uk_56f2b084e4b08af01be9f9ee?guccounter=1&guce_referrer=aHR0cHM6Ly93d3cuZ29vZ2xlLmNvbS8&guce_referrer_sig=AQAAADLTMAvvbO4UVZB7vpvgvV5Ue27ERzQkd7MZyAFYToDgmRPD_g_WDJPHNjAAvIFctKFCcfpZQXAgBMHL4enY0QIdVa_zkMt6fnphOURXdD_8QE12v9uVePQSRLtUObHh88IG7MBud1yDNJzbVxgBC5f3aSPdAEs9jVq_6_tE4Lf.

Based on the above, the art is in need of a technological solution that makes it easier for professionals to manage the volume of emails that they receive while out of the office. The present invention provides such a technological solution.

### SUMMARY OF THE INVENTION

The present invention provides a method and system whereby a person who is out of the office can enable his or her email account to, in response to the receipt of an email, automatically send a calendar invite to the email sender and recipient (or either of them) that schedules follow up between the two parties. In one preferred embodiment, the email recipient may designate a group of email senders such that, if the recipient receives an email from a sender in the designated group, a calendar invite is automatically sent to both the sender of the email and the recipient who is out of the office (in this embodiment, the recipient's receipt of an email from a sender who is not in the designated group would not result in the sending of a calendar invite). There are many ways in which the recipient may designate a group of senders from whom the receipt of an email would result in a calendar invite scheduling follow up to be automatically sent to both parties. For example, the recipient could designate a list of email contacts or could designate a list of email domains as groups to whom a calendar invite scheduling follow up is automatically sent.

As explained in more detail herein, the present invention may have several iterations or features. For example, the calendar invite sent to the sender and recipient according to the present invention may schedule the follow up for a date and time that is preprogrammed by the recipient leaving the office such that the scheduled date and time will be when the recipient has returned to the office. In addition, the recipient leaving the office may schedule reminders that remind the sender and the recipient that follow up is scheduled. In an embodiment of the invention that includes such reminders, while the calendar invite that is automatically sent schedules follow up between the sender and recipient at a specific date (and perhaps time) specified by the email recipient, a reminder will automatically arrive to both parties at a predetermined time prior to the follow up (for example, twenty-four hours in advance, one hour in advance, or fifteen minutes in advance) that reminds the parties the follow up is scheduled.

The details of one or more embodiments of the present invention are set forth in the accompanying drawings and the description below. It should be recognized that the foregoing and following description of the present invention are merely examples and do not encompass every possible use or advantage of the present invention. Other advantages of the present invention will be apparent to those skilled in the art.

### DETAILED DESCRIPTION OF THE DRAWINGS

The present invention may be readily understood by those of skill in the art by reference to the drawings and written description set forth herein. However, those of skill in the art will recognize that there are variations of the present invention that while not necessarily identical to the embodiments to the invention disclosed herein, are functionally equivalent to the invention disclosed herein. All such variations should be considered within the scope of the present invention.

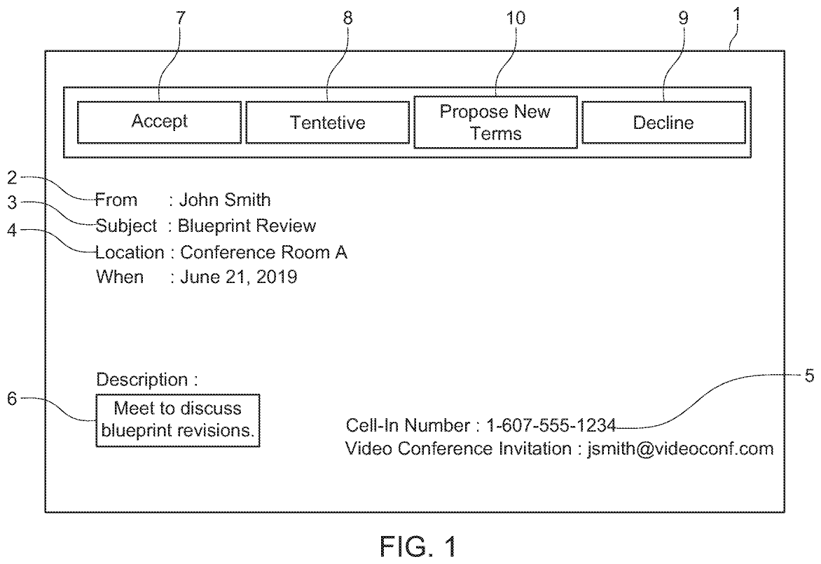

Referring now to FIG. 1, there is shown a representative sample of a calendar invite that may be utilized by users of several email platforms (such as Microsoft Outlook, Google's Gmail, etc). As can seen in FIG. 1, a calendar invite 1 typically includes information showing who is the sender of the calendar invite 2; the subject of the calendar invite 3; information as to whether the calendar invite is for an in-person meeting (and, if it is, the location) 4 or whether the meeting is intended to be conducted via a telephone or video conference 5; and a description of the meeting's purpose or other written information that the sender may include with the calendar invite 6. Calendar invites also include buttons that enable the recipient of the calendar invite to take action in response to the calendar invite. As shown in FIG. 1, calendar invites typically include an accept button 7; a tentative button 8; a decline button 9; and a button that would enable the recipient to propose new terms for the meeting 10, such as a different time or meeting location than that proposed by the original calendar invite sender. As noted above, if the recipient clicks the accept button, the sender is notified that the recipient has accepted the meeting. If the recipient declines or clicks the tentative button, the sender is notified of the recipient's choice. And if the recipient clicks the propose new terms button, the recipient may alter the terms of the proposed meeting and send to the original sender a calendar invite proposing new terms for the meeting. If the proposed meeting is to take place over telephone or video conference, the calendar invite will typically also include information sufficient information to facilitate the parties to meet by telephone or video conference 5.

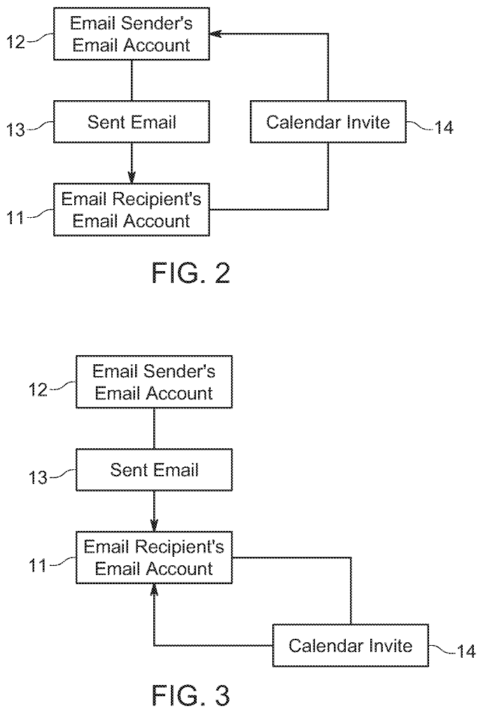

Referring now to FIG. 2, there is shown a flow chart illustrating one embodiment of the present invention. The method and system shown in FIG. 2 functions as follows: the email sender 12 sends an email 13 to the email recipient's email account 11. In response, the email recipient's email account 11 automatically sends to the email sender's email account 12 a calendar invite 14. The calendar invite 14 referenced in FIG. 2 could be for in-person follow up, follow up via telephone or video conference, could include any combination of information or buttons described in the calendar invite shown in FIG. 1, or could include any other information that the email recipient elects to include in the calendar invite 14.

Referring now to FIG. 3, there is shown a flow chart illustrating another embodiment of the present invention. The method and system disclosed in FIG. 3 functions as follows: the email sender 12 sends an email 13 to the email recipient's email account 11. In response, the email recipient's email account 11 automatically sends to the email recipient's email account 11 a calendar invite 14. The calendar invite 14 referenced in FIG. 3 could be for in-person follow up, follow up via telephone or video conference, could include any combination of information or buttons described in the calendar invite shown in FIG. 1, or could include any other information that the email recipient elects to include in the calendar invite 14.

There may be instances where it would be preferable for an email recipient to send himself or herself a calendar invite to schedule follow up (as shown in FIG. 3), as opposed to sending a calendar invite to the email sender to schedule follow up (as shown in FIG. 2). For example, the email recipient may be particularly diligent or a “type A” person, and as such the email recipient may prefer to have the calendar invite sent to his or her own email account so that they remain responsible for ensuring the follow up occurs. In addition, the email recipient may for various reasons prefer that calendar invites not be sent to email sender. For example, a lawyer may feel like it is the lawyer's responsibility, not the client's, to initiate follow up, and as such the lawyer may prefer that a calendar invite scheduling follow up in response to a client email be sent to the lawyer and not the client.

In other instances, it may be preferable for an email recipient if the calendar invite is sent to the sender's email account and not to the email recipient's own email account. For example, the email recipient may be self-aware and know that he or she is not good about following up on obligations or may simply be extremely busy. In other instances, the email recipient may regularly receive emails that for a variety of reasons do not necessarily warrant the email recipient initiating follow up. In such instances, it may be preferable to the email recipient to shift the responsibility of follow up to the email sender.

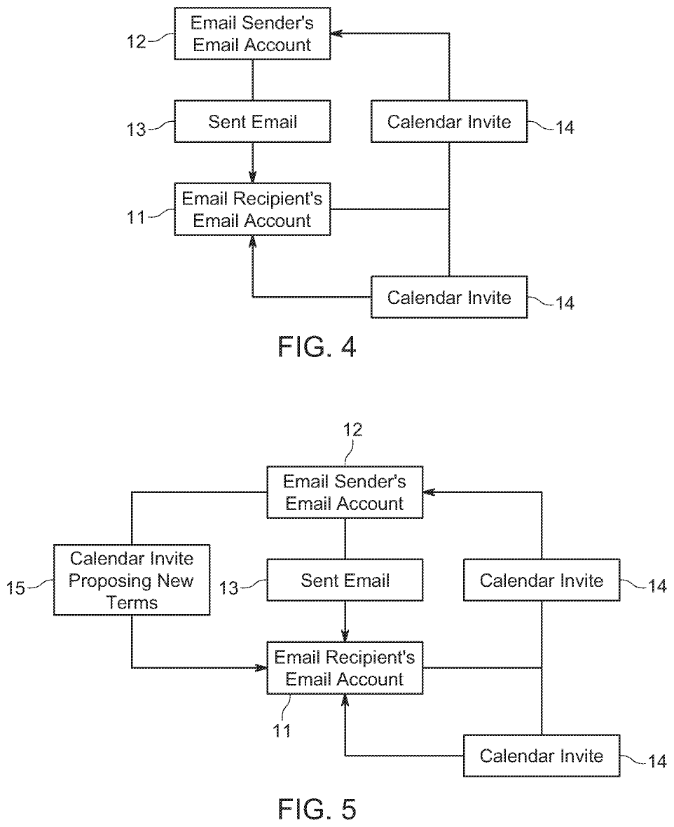

Still, in other instances it may be preferable for a calendar invite scheduling follow up to be sent to both the email sender and the email recipient—this embodiment of the present invention is illustrated in FIG. 4. The method and system disclosed in FIG. 4 functions as follows: the email sender 12 sends an email 13 to the email recipient's email account 11. In response, the email recipient's email account 11 automatically sends to the email recipient's email account 11 and to the email sender's email account 12 a calendar invite 14. The calendar invite 14 referenced in FIG. 4 could be for in-person follow up, follow up via telephone or video conference, could include any combination of information or buttons described in the calendar invite shown in FIG. 1, or could include any other information that the email recipient elects to include in the calendar invite 14.

Referring now to FIG. 5, there is shown a flow chart illustrating another embodiment of the present invention. The method and system disclosed in FIG. 5 functions as follows: the email sender 12 sends an email 13 to the email recipient's email account 11. In response, the email recipient's email account 11 automatically sends to the email recipient's email account 11 and to the email sender's email account 12 a calendar invite 14. In the embodiment shown in FIG. 5, in response to receiving the calendar invite 14, the email sender 12 proposes new terms for the scheduled follow up (e.g., a different time or location) by sending an amended calendar invite 15 to the email recipient's email account 11. The amended calendar invite 15 referenced in FIG. 5 could be for in-person follow up, follow up via telephone or video conference, could include any combination of information or buttons described in the calendar invite shown in FIG. 1, or could include any other information that the email recipient elects to include in the amended calendar invite 15.

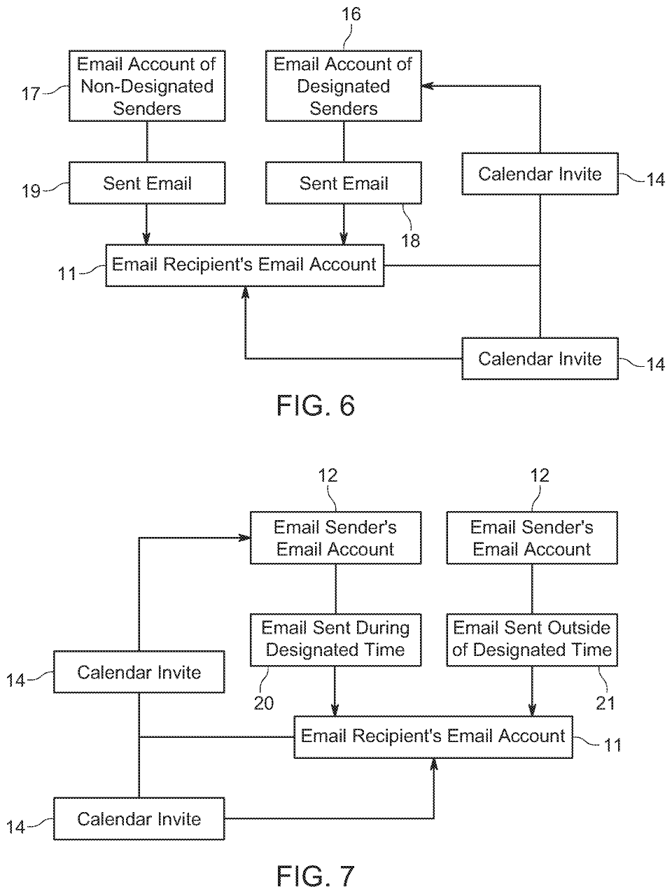

Referring now to FIG. 6, there is shown a flow chart illustrating another embodiment of the present invention. It may be the case that an email recipient may wish to schedule follow up only with specific persons or groups of persons. In the embodiment of the present invention shown in FIG. 6, the email recipient designates one or more persons as a group of email senders to whom a calendar invite scheduling follow up will be sent in the event that a person in the group sends the email recipient an email (this group is hereafter referred to as “Designated Senders” and is designated in the drawings included herewith as reference number 16). All persons not included in the group of Designated Senders shall be hereafter referred to as Non-Designated Senders and referred to in the drawings included herewith as reference number 17. The method and system disclosed in FIG. 6 functions as follows: an email 18 is sent from the email account of a Designated Sender 16 to the email recipient's email account 11. In response, the email recipient's email account 11 automatically sends to the Designated Sender's email account 16 and to the email recipient's email account 11 a calendar invite 14. However, in the embodiment shown in FIG. 6, if an email 19 is sent to the email recipient's email account 11 from an email account of a Non-Designated Sender 17, no calendar invite will be sent to the email account of the Non-Designated Sender 17 or to the email account of the email recipient 11. It should be noted that the although FIG. 6 shows a calendar invite 14 being sent to both the email account of the Designated Sender 16 and the email account of the email recipient 11, the email recipient of FIG. 6 could, as shown in FIG. 2, elect to have the calendar invite 14 shown in FIG. 6 sent only to the email account of the Designated Sender 16 or could, as shown in FIG. 3, elect to have the calendar invite 14 of FIG. 6 sent only to the account of the email recipient 11. The calendar invite 14 referenced in FIG. 6 could be for in-person follow up, follow up via telephone or video conference, could include any combination of information or buttons described in the calendar invite shown in FIG. 1, or could include any other information that the email recipient elects to include in the calendar invite 14.

Referring now to FIG. 7, there is shown a flow chart illustrating another embodiment of the present invention. It may be the case that an email recipient may wish to schedule follow up only in the event that an email is sent to the email recipient's email account during a specified period of time. This period of time could be any temporal designation, including but not limited to a period of hours, days, minutes, etc. For example, an email recipient may need to pick up their child from school everyday and doing so may cause the email recipient to be occupied every weekday between the hours of 3:00 PM and 5:00 PM. As explained herein, the embodiment of the present invention shown in FIG. 7 would allow such an email recipient's email account to automatically send calendar invites scheduling follow up in response to emails received during that 3:00 PM to 5:00 PM timeframe.

As shown in FIG. 7, the email recipient 11 designates a specific time during which calendar invites scheduling follow up shall be sent in the event that the email recipient receives an email. This type of temporal limitation is currently available for Out of Office Responses and those of skill in the art know how to enable such temporal limitation functionality. The method and system disclosed in FIG. 7 functions as follows: an email sent during the designated time 20 is sent from an email sender's email account 12 to the email recipient's email account 11. In response, the email recipient's email account 11 automatically sends a calendar invite 14 scheduling follow up to both the email sender's email account 12 and to the email recipient's email account 11. However, in the embodiment shown in FIG. 7, if the email recipient receives an email that is not sent during the designated time 21, no calendar invite scheduling follow up will be sent to the email accounts of the email sender 12 or the email recipient 11.

It should be noted that the although FIG. 7 shows a calendar invite 14 being sent to both the email account of the email recipient 11 and the email account of the email sender 12, the email recipient in FIG. 7 could, as shown in FIG. 2, elect to have the calendar invite 14 of FIG. 7 sent only to the email account of the email sender 12 or could, as shown in FIG. 3, elect to have the calendar invite 14 of FIG. 7 sent only to the account of the email recipient 11. The calendar invite 14 referenced in FIG. 7 could be for in-person follow up, follow up via telephone or video conference, could include any combination of information or buttons described in the calendar invite shown in FIG. 1, or could include any other information that the email recipient elects to include in the calendar invite 14.

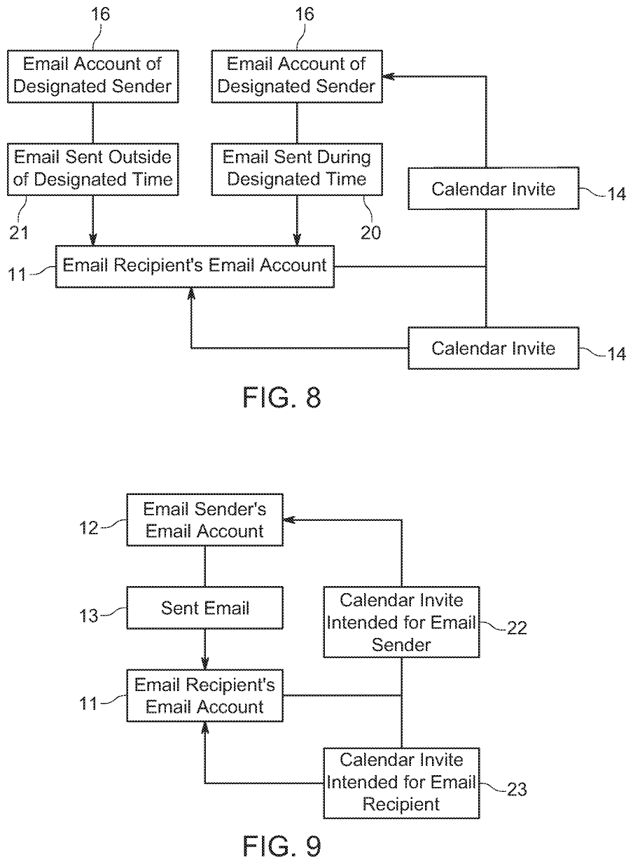

Referring now to FIG. 8, there is shown a flow chart illustrating another embodiment of the present invention. The embodiment of the present invention shown in FIG. 8 is a combination of the embodiments of the present invention that are shown in FIG. 6 and FIG. 7. In this regard, the embodiment of the present invention shown in FIG. 8 enables the email recipient to automatically send a calendar to invite to a Designated Sender that sends an email to the email recipient's email account during the Designated Time. Specifically, the embodiment of the present invention shown in FIG. 8 functions as follows: a Designated Sender 16 sends and email during the Designates Time 20 to the email recipient's email account 11. In response, the email recipient's email account 11 automatically sends to the Designated Sender's email account 16 a calendar invite 14. However, in the embodiment shown in FIG. 8, if a Designated Sender 16 sends to the email recipient 11 an email that is sent outside of the Designated Time 21, no calendar invite will be sent to the Designated Sender 16 or to the email recipient's email account 11. It should be further noted that in the embodiment of the present invention shown in FIG. 8, although it is not shown, by designating a group of Designated Senders as the only email sender accounts to which a calendar invite is automatically sent in response to receiving an email during the Designated Time, any email that is sent to the email recipient's email account from a Non-Designated sender's email account will not trigger the automatic sending of a calendar invite even if the email was sent during the Designated Time.

Referring now to FIG. 9, there is shown a flow chart illustrating another embodiment of the present invention. In the embodiment of the present invention shown in FIG. 9, the email recipient elects to send a different calendar invite to the email sender than the calendar invite that is sent to the email recipient. For example, the calendar invite that the email recipient structures to send to the email sender may be of a formal business tone, such as “Scheduled Follow Up With John Smith; Jun. 17, 2020 at 3:30 PM” whereas the calendar invite that the email recipient structures to send to himself or herself may simply read “Call John S., 6.17, 3:30.” There may be a variety of reasons why an email recipient may desire that the calendar invite sent to their own email account be different than the calendar invite that is sent an email sender's account. Specifically, the embodiment of the present invention shown in FIG. 9 functions as follows: the email sender 12 sends an email 13 to the email recipient's email account 11. In response, the email recipient's email account 11 automatically sends to the email recipient's email account 11 a calendar invite with terms specifically intended for the email recipient 23 and automatically to the email sender's email account 12 a calendar invite with terms specifically intended for the email sender 22 and that vary from the terms of the calendar invite 23 sent to the email recipient's email account.

Throughout this specification, those of skill in the art will recognize that email senders and recipients act through their email accounts. However, those of the skill in the art will also recognize that references in this specification to calendar invites being automatically sent by the email account of an email recipient means that—like Out of Office Replies—the calendar invites are automatically sent (i.e., the email user is does not manually send each and every such calendar invite) by the email recipient's email account as a result of the email recipient enabling and setting up such automatic sending in advance of receiving an email that triggers the calendar invite being automatically sent.

Having thus described the present invention, the scope of patent protection sought for the present invention is delineated in the following claims.

What is claimed is:

1. A method and system for managing email correspondence, comprising:
a server for processing electronic mail wherein the server also includes electronic calendar functionality; and
wherein in response to an email recipient's email account receiving at least one email from an email sender's email account, the email recipient's email account automatically sends a calendar invite to the email sender's email account.

2. The method and system claimed in claim 1, wherein the email recipient's email account also automatically sends the calendar invite to the email recipient's email account.

3. The method and system claimed in claim 2, wherein in response to the receipt of at least one email from an email account included within a designated group of email accounts, the email recipient's email account automatically sends the calendar invite to both the email account included within the designated group from which the at least one email was sent and the email recipient's email account, but if the email recipient's email account receives an email from an email account not included within the designated group, the email recipient's email account does not automatically send a calendar invite.

4. The method and system claimed in claim 2, wherein in response to the receipt of at least one email from an email account, and wherein the at least one email is received by the email recipient's email account during a designated timeframe, the email recipient's email account automatically sends the calendar invite to both the email account from which the at least one email was sent and the email recipient's email account, but if the email recipient's email account receives an email at a time that is not within the designated timeframe, the email recipient's email account does not automatically send a calendar invite.

5. The method and system claimed in claim 2, further including the steps of:
the email sender to whom the calendar invite was automatically sent modifies the terms of the calendar invite; and
the email sender sends the modified calendar invite to the email recipient's email account.

6. The method and system claimed in claim 2, wherein the calendar invite automatically sent to the email sender's email account is not identical to the calendar invite automatically sent to the email recipient's email account.

7. The method and system claimed in claim 2, wherein in response to the receipt of at least one email from an email account included within a designated group of email accounts, and wherein the at least one email is received by the email recipient's email account during a designated timeframe, the email recipient's email account automatically sends the calendar invite to both the email account included within the designated group from which the at least one email was sent and the email recipient's email account, but if the email recipient's email account receives an email from an email account not included within the designated group or if the email recipient's email account receives an email from an email account that is included within the designated group but at a time that is not within the designated timeframe, the email recipient's email account does not automatically send a calendar invite.

8. A method and system for managing email correspondence, comprising:
a server for processing electronic mail wherein the server also includes electronic calendar functionality; and
wherein in response to an email recipient's email account receiving at least one email from an email sender's email account, the email recipient's email account automatically sends a calendar invite to the email recipient's email account.

9. The method and system claimed in claim 8, wherein in response to the receipt of at least one email from an email account included within a designated group of email accounts, the email recipient's email account automatically sends the calendar invite to the email recipient's email account, but if the email recipient's email account receives an email from an email account not included within the designated group, the email recipient's email account does not automatically send a calendar invite.

10. The method and system claimed in claim 8, wherein in response to the receipt of at least one email from an email account, and wherein the at least one email is received by the email recipient's email account during a designated timeframe, the email recipient's email account automatically sends the calendar invite to the email recipient's email account, but if the email recipient's email account receives an email at a time that is not within the designated timeframe, the email recipient's email account does not automatically send a calendar invite.

11. The method and system claimed in claim 8, wherein in response to the receipt of at least one email from an email account included within a designated group of email accounts, and wherein the at least one email is received by the email recipient's email account during a designated timeframe, the email recipient's email account automatically sends the calendar invite to the email recipient's email account, but if the email recipient's email account receives an email from an email account not included within the designated group or if the email recipient's email account receives an email from an email account that is included within the designated group but at a time that is not within the designated timeframe, the email recipient's email account does not automatically send a calendar invite.

12. The method and system claimed in claim 1, wherein in response to the receipt of at least one email from an email account included within a designated group of email accounts, the email recipient's email account automatically sends the calendar invite to the email account included within the designated group from which the at least one email was sent, but if the email recipient's email account receives an email from an email account not included within the designated group, the email recipient's email account does not automatically send a calendar invite.

13. The method and system claimed in claim 1, wherein in response to the receipt of at least one email from an email account, and wherein the at least one email is received by the email recipient's email account during a designated timeframe, the email recipient's email account automatically sends the calendar invite to the email account from which the at least one email was sent, but if the email recipient's email account receives an email at a time that is not within the designated timeframe, the email recipient's email account does not automatically send a calendar invite.

14. The method and system claimed in claim 1, wherein in response to the receipt of at least one email from an email account included within a designated group of email accounts, and wherein the at least one email is received by the email recipient's email account during a designated timeframe, the email recipient's email account automatically sends the calendar invite to the email account from which the at least one email was sent, but if the email recipient's email account receives an email from an email account not included within the designated group or if the email recipient's email account receives an email from an email account that is included within the designated group but at a time that is not within the designated timeframe, the email recipient's email account does not automatically send a calendar invite.
